(19) United States
(12) Patent Application Publication
(10) Pub. No.: US 2011/0047493 A1
(43) Pub. Date: Feb. 24, 2011

(54) METHOD FOR PROVIDING CONTROL WIDGET AND DEVICE USING THE SAME

(75) Inventors: Ju-yun SUNG, Yongin-si (KR); Hee-jeong CHOO, Anyang-si (KR); Keum-koo LEE, Seongnam-si (KR); Ji-young KWAHK, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/862,415

(22) Filed: Aug. 24, 2010

(30) Foreign Application Priority Data
Aug. 24, 2009 (KR) 10-2009-0078354

(51) Int. Cl. G06F 3/048

(52) U.S. Cl. 715/765

(57) ABSTRACT

A method for providing a control widget and a device using the same are provided. According to the method, a control widget, used for inputting a control command with respect to a portable device, is received and executed, so that the inputted user command is transferred to the controlled device using the executed control widget. As a result, a control widget to control the portable device at a remote distance is conveniently received and installed on the device.

### PRIORITY

This application claims priority to Korean Patent Application No. 10-2009-0078354, filed in the Korean Intellectual Property Office on Aug. 24, 2009, the contents of which are incorporated herein by reference.

### BACKGROUND OF THE INVENTION

1. Field of the Invention

The present invention relates generally to a method and device for providing a control widget, and more particularly, to a method and device for receiving a widget from a server and providing a user with a service.

2. Description of the Related Art

With the proliferation of digital devices, users today have a variety of digital devices at their disposal.

Digital devices have enhanced convenience and communication in human lives. The digital technology has quickly developed, particularly in recent years, thereby achieving even higher performance and diversity.

Yet, consumers are seeking even more convenient and affluent lives, and are seeking higher performance and functionality in the digital devices.

Meanwhile, there is a limit to the number of functions that a single digital device can provide. Accordingly, a method is required, which enables convergence of functions of digital devices and thus further enhances user convenience.

### SUMMARY OF THE INVENTION

Embodiments of the present invention overcome the aforementioned disadvantages occurring in the prior art.

According to the present invention, a method of providing a control widget and a device using the same are provided, in which a control widget is installed onto a device, allowing an input of a control command to the device of interest from a remote distance.

The method for providing a control widget includes receiving a control widget for use in inputting a control command with respect to a controlled device, executing the received control widget, and transferring a user command, inputted using the executed control widget, to the controlled device.

The method further includes receiving an input of a command to edit the control widget, and editing the control widget according to the inputted command to edit.

The editing includes at least one of changing a shape of the control widget, deleting the control widget, changing an arrangement of control icons constructing the control widget, adding or deleting control icons constructing the control widget, and changing a position of the control widget.

The method additionally includes displaying a first control widget for use in inputting a control command with respect to a first controlled device, together with a second control widget for use in inputting a control command with respect to a second controlled device, and transferring, if a first user command is inputted through the first control widget, the first user command to the first controlled device, and transferring, if a second user command is inputted through the second control widget, the second user command to the second controlled device.

The control widget may be provided separately for each type of the controlled device.

The control widget may be pre-stored in a server or the controlled device.

The method additionally includes updating the control widget.

The control widget may connect to a server or the controlled device periodically to check information on the updates.

The control widget may receive information on the updates from the server or the controlled device.

According to the present invention, a controlled device controlled by a control widget of a controlling device includes a network interface which transmits the control widget for use in inputting a control command with respect to the controlled device, and receives a user command inputted using the control widget executed by the controlling device, and a control unit which controls the controlled device according to the user command.

The control widget is provided separately for each type of the controlled device.

The network interface provides the controlling device with information on the updates of the control widget.

According to the present invention, a controlling device controlling a controlled device by a control widget includes a network interface which receives a control widget for use in inputting a control command with respect to the controlled device, and a control unit which executes the received control widget, and controls the controlling device to transfer a user command, which is inputted using the executed control widget, to the controlled device.

The control widget may be received from a server or the controlled device.

The controlling device additionally includes a touch screen to receive a command to edit with respect to the control widget, wherein the control unit controls the controlling device to edit the control widget according to the received command to edit.

The editing includes at least one of changing a shape of the control widget, deleting the control widget, changing an arrangement of control icons constructing the control widget, adding or deleting control icons constructing the control widget, and changing a position of the control widget.

The control widget may be provided separately for each type of the controlled device.

The control unit controls the controlling device to update the control widget.

The network interface may connect to a server or the controlled device periodically to check information on the updates.

The network interface may receive information on the updates from a server or the controlled device.

According to the present invention, a system for controlling a controlled device by a control widget of a controlling device includes the controlled device which transmits the control widget for use in inputting a control command with respect to the controlled device, and performs a user command which is inputted using the control widget executed by the controlling device, and the controlling device which receives the control widget, executes the received control widget, and transfers a user command, which is inputted using the executed control widget, to the controlled device.

If the controlling device receives a command to edit with respect to the control widget, the controlling device edits the control widget according to the received command to edit.

The editing includes at least one of changing a shape of the control widget, deleting the control widget, changing an arrangement of control icons constructing the control widget, adding or deleting control icons constructing the control widget, and changing a position of the control widget.

The controlling device updates the control widget.

The control widget may connect to the controlled device periodically to check information on the updates, or receive information on the updates from the controlled device.

According to the present invention, a control widget controlling system for controlling a controlled device by a control widget includes a server which transmits the control widget for use in inputting a control command with respect to the controlled device, a controlling device which receives the control widget, executes the received control widget, and transfers a user command, which is inputted using the executed control widget, to the controlled device, and the controlled device which performs the transferred user command.

The controlling device edits the control widget, when receiving a command to edit with respect to the control widget, according to the received command to edit.

The editing includes at least one of changing a shape of the control widget, deleting the control widget, changing an arrangement of control icons constructing the control widget, adding or deleting control icons constructing the control widget, and changing a position of the control widget.

The controlling device updates the control widget.

The control widget may connect to a server periodically to check information on the updates, or receives information on the updates from the server.

According to the embodiments, control widgets for controlling the controlled devices at a remote distance can be conveniently downloaded and installed onto the devices, as a result of which a user may control the plurality of controlled devices from a remote distance through one device.

Furthermore, since the control widget is editable, more user preferences are considered.

### BRIEF DESCRIPTION OF THE DRAWINGS

The above and/or other aspects of the present invention will be more apparent by describing certain embodiments thereof with reference to the accompanying drawings, in which:

FIG. 1 illustrates a network according to the present invention;

FIG. 2 illustrates a method for downloading a control widget, editing the downloaded control widget according to a user's preference, and controlling home devices using the control widget, according to the present invention;

FIG. 3 illustrates control widgets according to the present invention;

FIGS. 4 and 5 illustrate editing of a control widget according to the present invention; and

FIG. 6 illustrates a diagram of a mobile phone of FIG. 1.

### DETAILED DESCRIPTION OF EMBODIMENTS OF THE INVENTION

Embodiments of the present invention will now be described in detail with reference to the accompanying drawings. It should be noted that throughout the drawings, the same drawing reference numerals will be construed to refer to the same elements, features and structures. In addition, descriptions of well-known functions and constructions are omitted for clarity and conciseness.

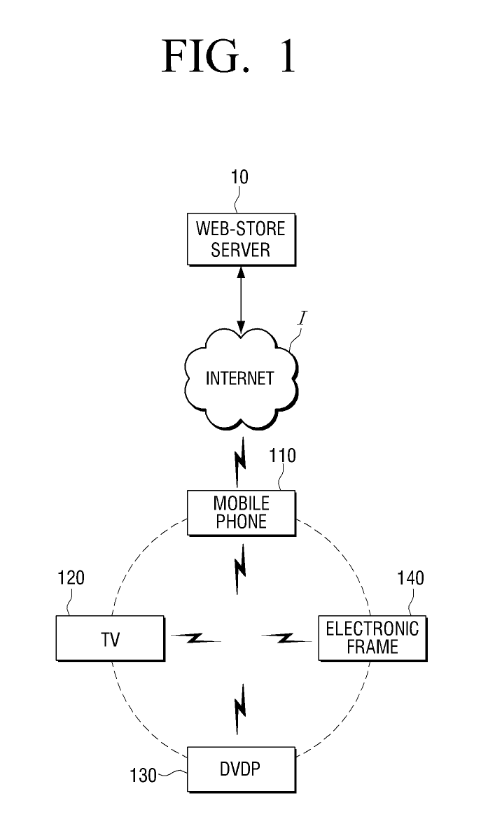

FIG. 1 illustrates a network according to the present invention.

Referring to FIG. 1, the network includes a mobile phone 110, a TeleVision (TV) 120, a Digital Video Disc Player (DVDP) 130, and an electronic frame 140 connected to one another for mutual communication.

The mobile phone 110 may be connected communicatively to a web-store server 10 via the Internet (I).

The mobile phone 110 may operate as a controlling device, in which case the other home devices such as the TV 120, the DVDP 130 and the electronic frame 140 may operate as the controlled devices. The web-store server 10 may operate as a server that mutually communicates with the controlling device.

The control widget is used to control and command the home devices 120, 130, 140 from a remote distance via the mobile phone 110. The control widget is customized and used for each of the home devices 120, 130, 140. In other words, a TV control widget to control and command the TV 120, a DVDP control widget to control and command the DVDP 130, and an electronic frame control widget to control and command the electronic frame 140, are provided separately from each other.

The web-store server 10 may include control widgets for respective products and models.

The home devices may also include control widgets designed for each according to their product and model categories.

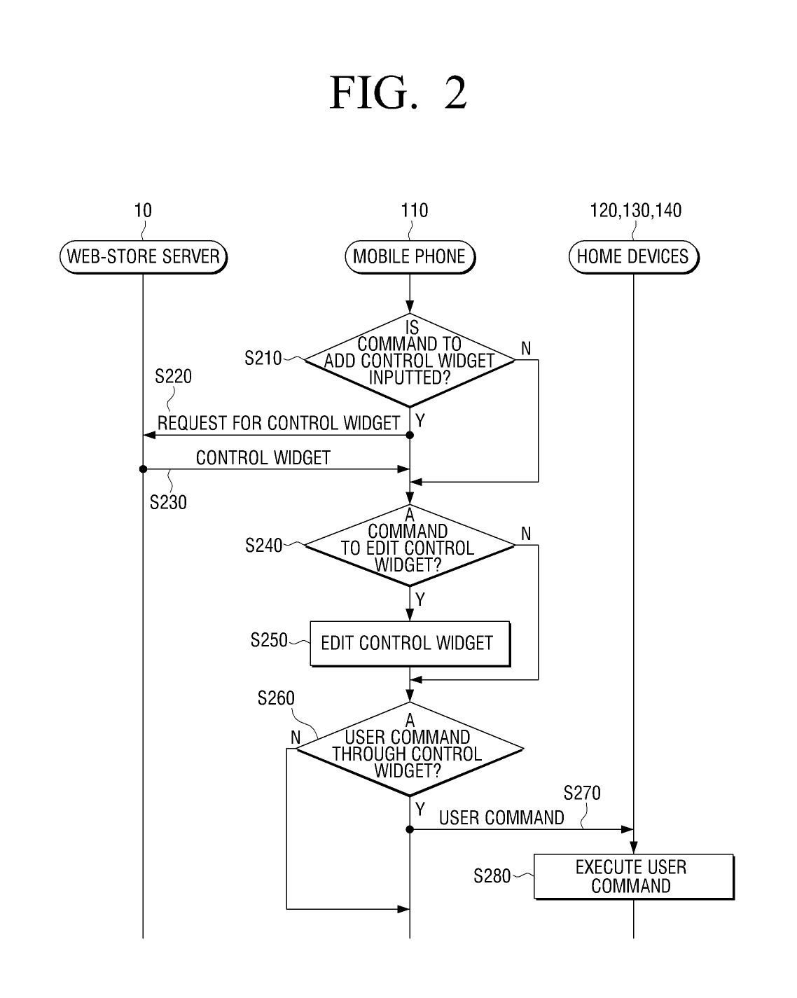

FIG. 2 illustrates a method of providing a control widget according to the present invention.

In the example explained below, the mobile phone 110 receives a control widget from the web-store server 10. However, this example is provided only for illustrative purposes, and other examples are applicable. For example, instead of the mobile phone 110, the other home devices such as the TV 120, the DVDP 130, or the electronic frame 140, may operate to transmit a corresponding control widget which is received from the web-store server 10 and stored therein, or a control widget which is stored therein previously, to the mobile phone 110.

At S210-Y, if a user inputs a command to add a control widget, at S220, the mobile phone 110 requests the web-store server 10 for a control widget of interest over the Internet (I). Alternatively, the mobile phone 10 may directly request the corresponding home device 120, 130, 140 for the control widget of interest.

By way of example, at S210, if a user gives an instruction to add a DVDP control widget, at S220, the mobile phone 110 may request the web-store server 10 or the home device 120, 130, 140 for the DVDP control widget. The request made at S220 may contain a DVDP model number, by which a requested home device is addressed.

At S230, the mobile phone 110 may receive a control widget from the web-store server 10. Alternatively, the mobile phone 10 may receive a control widget from the home device 120, 130, 140. The mobile phone 110 may then install the control widget received at S230.

A new control widget is thus installed on the mobile phone 110. The above processes may be implemented generally, if the user purchases a new home device or intends to manipulate his/her home device from a remote distance with the control widget executed on the mobile phone 110.

If the user intends to discontinue using or manipulating the home device from a remote distance using the control widget executable on the mobile phone 110, the user may give a command to delete the stored control widget of the home device from the mobile phone 110.

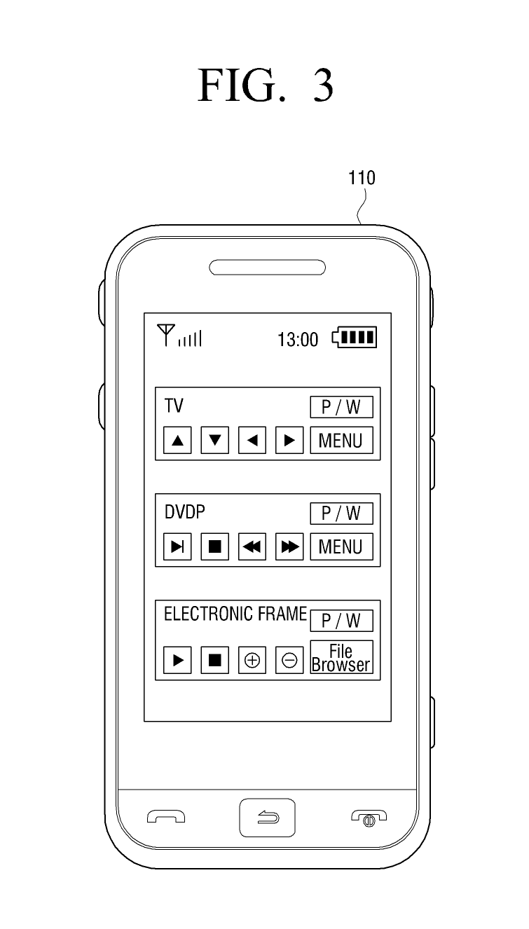

FIG. 3 illustrates the mobile phone 110, on a stand-by screen of which the control widgets thereof are arranged. Specifically, the mobile phone 110 includes a TV control widget, a DVDP control widget, and an electronic frame control widget executed and presented on the stand-by screen of the mobile phone 110.

The user may edit the control widgets appearing on the mobile phone 110 according to her/her preferences. Referring to FIG. 2, at S240-Y, if the user inputs a command to the mobile phone 110 to edit the control widget, at S250, the mobile phone 110 may edit the control widget according to the details of edition inputted at S240.

Editing the control widget may include changing the shape of a control widget, adding/deleting a control widget, changing an arrangement of control icons constructing the control widget, or adding/deleting the control icons constructing the control widget.

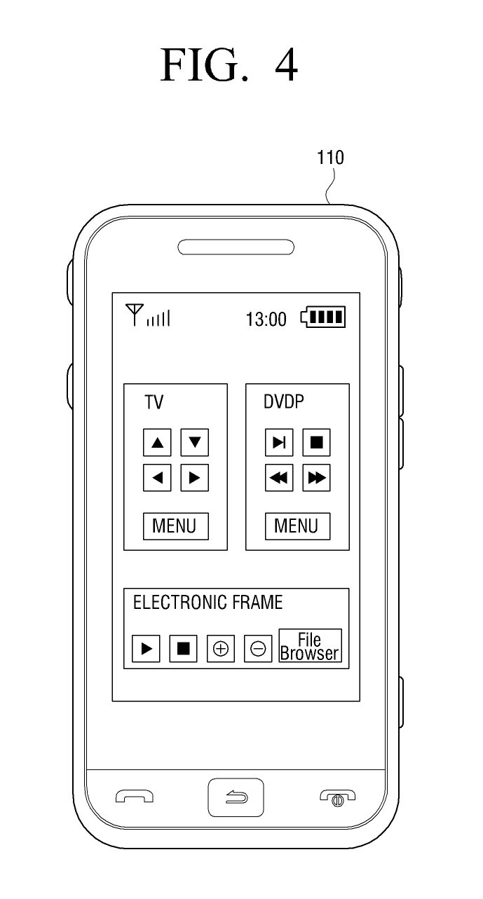

FIG. 4 illustrates the result after the shapes of the TV control widget and DVDP control widget of FIG. 3 are edited. Also, according to FIG. 4, the arrangement of the control icons constructing the TV control widget and the control icons constructing the DVDP control widget is changed.

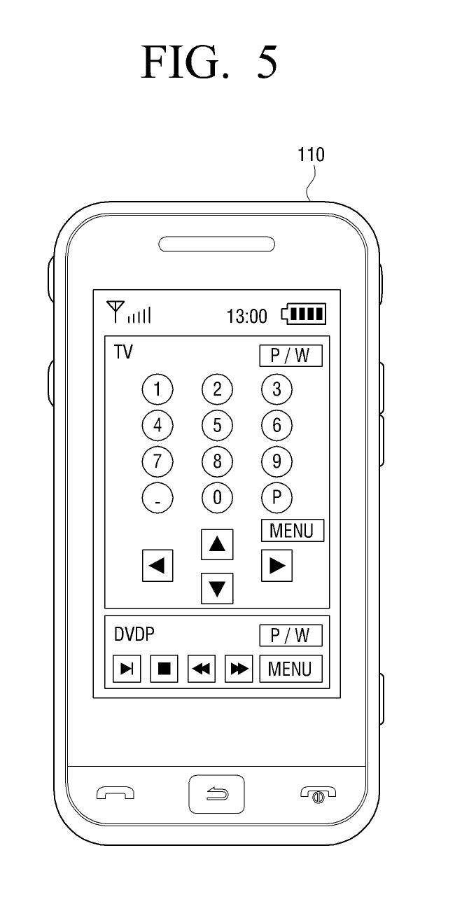

FIG. 5 illustrates the result after the shape of the TV control widget of FIG. 3 is edited and control icons constructing the TV control widget are added. Also, according to FIG. 5, the electronic frame control widget of FIG. 3 is deleted.

The particular manner of editing the control widget is explained above only for illustrative purposes. Therefore, different manners of editing may also be implemented. For example, regarding editing a position of a control widget, it is possible to change the position of the control widget on the stand-by screen of the mobile phone 110 according to the user's preferences. Additionally, it is also possible to edit the manner of adding a control widget that does not appear on the stand-by screen.

Referring back to FIG. 2, at S260-Y, if the user inputs a command using the control widget appearing on the mobile phone 110, at S270, the mobile phone 110 may transmit the inputted user command of S260 to a corresponding home device 120, 130 or 140.

Specifically, if the user inputs a user command using the TV control widget at S240, the mobile phone 110 transmits the inputted user command to the TV 120. If the user inputs a user command using the DVDP control widget at S240, the mobile phone 110 transmits the inputted user command to the DVDP 130. If the user inputs a user command using the electronic frame control widget at S240, the mobile phone 110 transmits the inputted user command to the electronic frame 140.

At S280, the home device 120, 130, or 140 in receipt of the user command of S270 may execute the transmitted user command.

Although not illustrated in FIG. 2, the control widgets installed on the mobile phone 110 may be updated. In other words, it is possible for an updated control widget to be received from the web-store server 10 and to replace the existent installed control widget.

Regarding the control widget updates, the control widget installed on the mobile phone 110 may possibly connect to the web-store server 10 or the home devices 120, 130, 140 periodically to check the information on the updates.

Additionally, the web-store server 10 or the home devices 120, 130, 140 may transmit the information on the updates to the mobile phone 110, in which case the mobile phone 110, in receipt of the information on the updates, may update the control widget installed thereon accordingly. In other words, if the control widget on the web-store server 10 is updated, the web-store server 10 may inform the mobile phone 110 of such update so that the mobile phone 110 updates the control widget accordingly.

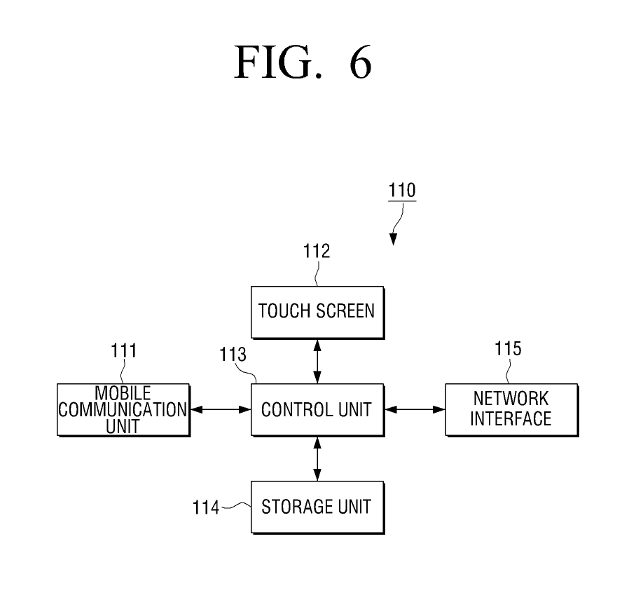

FIG. 6 illustrates a diagram of the mobile phone 110 of FIG. 1.

Referring to FIG. 6, the mobile phone 110 includes a mobile communication unit 111, a touch screen 112, a control unit 113, a storage unit 114, and a network interface 115.

The mobile communication unit 111 includes major and subsidiary functions of the mobile phone 110, such as mobile phone calling, Short Messaging Service (SMS), Digital Multimedia Broadcasting (DMB) broadcast reception, or photographing.

The touch screen 112 may provide a function as a display on which screens necessary for the mobile phone calling or SMS providing, DMB broadcast or the above-explained control widgets are displayed, and a function as an input through which the user inputs commands mainly by touching.

The storage unit 114 provides a space to store programs and data necessary for the driving of the mobile phone 110, and downloaded control widgets.

The network interface 115 is communicatively connected to the web-store server 10 via the Internet, and receives control widgets from the web-store server 10. The network interface 115 also receives the control widgets from the home devices 120, 130, 140. Additionally, the network interface 115 is communicatively connected to the nearby home devices 120, 130, 140 and transmits a user command inputted through the touch screen 112 to the connected home devices 120, 130, 140.

The control unit 113 controls the mobile communication unit 111, the touch screen 112, the control unit 113, the storage unit 114, and the network interface 115 to receive and edit the control-widget and transmit the user command using the control-widget, in order to perform the operations of the mobile phone 110 shown in FIG. 2.

Referring back to FIG. 1, the home devices 120, 130, 140 may include a control unit (not illustrated), a storage unit (not illustrated), and a network interface (not illustrated).

The storage unit may provide a storage space to store programs and data necessary for driving the home devices 120, 130, 140, or control widgets, either previously stored or newly received from the web-store server 10.

The network interface may transmit a control widget for use in inputting a control command with respect to the home device 120, 130, 140, and receive a user command that is inputted using the control widget executed by the mobile phone 110.

The network of FIG. 1 is provided only for illustrate purposes. Therefore, the same technical concept of the embodiment is applicable to other networks including different types of devices from those of FIG. 1. For example, a mobile device other than the mobile phone 110 may be implemented to control the home devices. Such other mobile devices may include, a Personal Digital Assistant (PDA), Portable Media Player (PMP), MP3 player, digital camera, portable game player, electronic book, or note Personal Computer (PC).

Furthermore, the mobile phone 110 controlling the other home devices 120, 130, 140 may be implemented as not only a mobile device, but also a standalone device with display function, such as a TV, electronic frame, or a desktop PC.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for providing a control widget in a portable device, comprising:
receiving a control widget for use in inputting a control command with respect to the portable device;
executing the received control widget; and
transferring a user command, inputted using the executed control widget, to the portable device.

2. The method of claim 1, further comprising:
receiving an input of a command to edit the control widget; and
editing the control widget according to the inputted command to edit.

3. The method of claim 2, wherein the editing comprises at least one of: changing a shape of the control widget, deleting the control widget, changing an arrangement of control icons constructing the control widget, adding or deleting control icons constructing the control widget, and changing a position of the control widget.

4. The method of claim 1, further comprising:
displaying a first control widget for use in inputting a control command with respect to a first controlled device, together with a second control widget for use in inputting a control command with respect to a second controlled device;
transferring a first user command to the first controlled device, if the first user command is inputted through the first control widget; and
transferring a second user command to the second controlled device, if a second user command is inputted through the second control widget

5. The method of claim 1, wherein the control widget is provided separately for each type of the controlled device.

6. The method of claim 1, wherein the control widget is previously stored in a server or the controlled device.

7. The method of claim 1, further comprising updating the control widget.

8. The method of claim 7, wherein the control widget connects to a server or the controlled device periodically to check for information on the updates.

9. The method of claim 7, wherein the control widget receives information on the updates from the server or the controlled device.

10. A portable device controlled by a control widget of a controlling device, the portable device comprising:
a network interface which transmits the control widget for use in inputting a control command with respect to the portable device, and receives a user command inputted using the control widget executed by the portable device; and
a control unit which controls the portable device according to the user command.

11. The controlled device of claim 10, wherein the control widget is provided separately for each type of the portable device.

12. The controlled device of claim 10, wherein the network interface provides the controlling device with information on the updates of the control widget.

13. A controlling device for controlling a portable device by a control widget, the controlling device comprising:
a network interface which receives a control widget for use in inputting a control command with respect to the portable device; and
a control unit which executes the received control widget, and controls the controlling device to transfer a user command, which is inputted using the executed control widget, to the portable device.

14. The controlling device of claim 13, wherein the control widget is received from a server or the portable device.

15. The controlling device of claim 13, further comprising a touch screen for receiving a command to edit with respect to the control widget, wherein the control unit controls the controlling device to edit the control widget according to the received command to edit.

16. The controlling device of claim 15, wherein the editing comprises at least one of changing a shape of the control widget, deleting the control widget, changing an arrangement of control icons constructing the control widget, adding or deleting control icons constructing the control widget, and changing a position of the control widget.

17. The controlling device of claim 13, wherein the control widget is provided separately for each type of the portable device.

18. The controlling device of claim 13, wherein the control unit controls the controlling device to update the control widget.

19. The controlling device of claim 18, wherein the network interface connects to a server or the portable device periodically to check for information on the updates.

20. The controlling device of claim 18, wherein the network interface receives information on the updates from a server or the portable device.

21. A control widget controlling system for controlling a portable device by a control widget of a controlling device, the control widget controlling system comprising:
the portable device which transmits the control widget for use in inputting a control command with respect to the portable device, and performs a user command which is inputted using the control widget executed by the controlling device; and
the controlling device which receives the control widget, executes the received control widget, and transfers a user command, which is inputted using the executed control widget, to the portable device.

22. The system of claim 21, wherein, if the controlling device receives a command to edit with respect to the control widget, the controlling device edits the control widget according to the received command to edit.

23. The system of claim 22, wherein the editing comprises at least one of changing a shape of the control widget, deleting the control widget, changing an arrangement of control icons constructing the control widget, adding or deleting control icons constructing the control widget, and changing a position of the control widget.

24. The system of claim 21, wherein the controlling device updates the control widget.

25. The system of claim 24, wherein the control widget connects to the portable device periodically to check for information on the updates, or receives information on the updates from the portable device.

26. A control widget controlling system for controlling a portable device by a control widget, the system comprising:
a server which transmits the control widget for use in inputting a control command with respect to the portable device;
a controlling device which receives the control widget, executes the received control widget, and transfers a user command, which is inputted using the executed control widget, to the portable device; and
the portable device which performs the transferred user command.

27. The system of claim 26, wherein when the controlling device receives a command to edit with respect to the control widget, the controlling device edits the control widget according to the received command to edit.

28. The system of claim 27, wherein the editing comprises at least one of changing a shape of the control widget, deleting the control widget, changing an arrangement of control icons constructing the control widget, adding or deleting control icons constructing the control widget, and changing a position of the control widget.

29. The system of claim 26, wherein the controlling device updates the control widget.

30. The system of claim 29, wherein the control widget connects to a server periodically to check information on the updates, or receives information on the updates from the server.
